(19) United States
(12) Patent Application Publication
(10) Pub. No.: US 2005/0042416 A1
(43) Pub. Date: Feb. 24, 2005

(54) Insulation system having vacuum encased honeycomb offset panels

(76) Inventors: James B. Blackmon, Brownsboro, AL (US); Francis C. Wessling, Huntsville, AL (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/645,110

(22) Filed: Aug. 21, 2003

(51) Int. Cl. B32B 3/12

(52) U.S. Cl. 428/116

(57) ABSTRACT

An insulation system comprising layers of honeycomb cores where each core is enclosed in a sealed container made of radiation barrier material. The container is evacuated and becomes a vacuum enclosure for the honeycomb cores. To reduce the heat transfer between the honeycomb cores, the cores are placed in an offset arrangement.

### STATEMENT REGARDING FEDERALLY SPONSORED RESEARCH OR DEVELOPMENT

The U.S. government has a paid-up license in this invention and the right in limited circumstances to require the patent owner to license others as provided for by the terms of NASA cooperative agreement no. NCC8-132.

### TECHNICAL FIELD

The present invention is generally related to high thermal resistive materials, and, more particularly, is related to layers of honeycomb cores that are positioned in an offset arrangement and encased in a vacuum enclosure of radiation barrier material.

### BACKGROUND OF THE INVENTION

Panels that have a high thermal resistance are useful as insulators for a variety of applications and products. For example, containers utilizing thermal energy phase change material for keeping temperature sensitive materials, such as food and medicine, within a given temperature range can use such panels to significantly increase storage time. Additional product areas where high thermal resistance materials are useful include, for example, building insulation, electronic enclosures, aerospace products, fuel storage, munitions storage, beverage storage, and potable water storage.

An insulated carrier, a container for holding temperature sensitive materials, for NASA requires thermal control for transporting experimental materials into orbit. It is required in some cases to keep experimental materials at a specified temperature, such as zero degrees centigrade, for more than two weeks. The typical insulated carrier for transporting experimental materials is a container having a cavity for holding the experimental materials where the cavity is surrounded by hollow walls that are filled with high thermal resistive materials such as INSTILL™, silica powder, open-cell rigid polyurethane, Aerogel™ or other materials serving as insulators. Such insulating materials are typically placed between the walls of a rigid structure that are designed for that purpose. The conventional high thermal resistance materials contribute little, if any, structural value to the container.

In the construction of a fuel tank for aerospace applications, a structural specification and a thermal specification are provided. First, the fuel tank is designed to meet the structural specifications and then insulation materials are provided to meet the thermal specifications. However, the materials used to provide insulation are considered to have an insignificant structural value. In one such design, a tank is built to meet the structure specifications and then foam, having high thermal resistance, is sprayed on the outside of the tank. The foam may need a protective coating or may be exposed directly to the environment. The foam must be thick enough to keep a fuel element, such as liquid oxygen, in a required temperature range.

As mentioned above, the design process for many insulated structures is a two-step process. First the structural requirements are met. Then insulation is added to satisfy the heat transfer requirements. Although there is an interaction between the structural and thermal designers, the structure and the thermal control considerations are generally not approached as an integral design effort. Because the best insulators, those with high thermal resistance, have little or no structural value, the structural designers provide spaces or cavities for holding insulation materials or use a foam coating.

A honeycomb core is comprised of a multiplicity of transversely extending open-ended cells. Honeycomb panels are usually comprised of a honeycomb core having sheets of material glued on each of two parallel ends of the core. Such conventional honeycomb panels are known to be light in weight and have strength and are utilized to reduce weight without sacrificing stiffness. In general, honeycomb panels have a low to medium thermal resistance with thermal resistance values around one hundredth of the best insulating materials such as Aerogel™, INSTILL™ and others. A known way of improving the thermal resistance of honeycomb panels is to fill the cells with high thermal resistance materials. Although the high thermal resistance materials contained in the cells significantly improve the insulation characteristics of the honeycomb panels, the weight of the panel is increased and the cost may be unacceptable for many applications.

The structural properties of honeycombs are well known and may be provided by the manufacturer. The open-ended cells of honeycomb structures are available in a variety of geometric shapes including a hexagon, a square, a triangle, a circle, and others. In general, the shape of the core and core materials may be selected by a designer and additional cost is dependent upon the manufacturing process. The hexagonal core shape is perhaps the most used core shape and may be considered as the conventional honeycomb core. Honeycomb cores are typically fabricated from layers of relatively thin materials that are pulled into a honeycomb shape and then hold the shape because of some sort of hardening process (chemical or thermal setting process). For metals, the cellular shape may be formed by various fabrication processes, including extruding, welding, brazing, and bonding. Honeycombs may be made of impregnated paper, aluminum foil, alloy foils, and other materials known to those in the art of honeycomb fabrication. Because the honeycomb core technology area is mature, no attempt is made within this patent application to describe the structural parameters of or manufacturing processes for honeycomb structures.

Although the strength and stiffness of honeycomb cores are desirable structural characteristics, the conventional techniques for increasing the thermal resistance of honeycombs do not typically provide a panel with both desirable thermal and strength characteristics. Thus, a heretofore unaddressed need exists in the industry to address the aforementioned deficiencies and inadequacies.

### SUMMARY OF THE INVENTION

Embodiments of the present invention provide an insulation system having high thermal resistance and strength.

In a first embodiment an insulation system comprises a first honeycomb core encased in an evacuated container of insulating material. A second honeycomb panel having a honeycomb core is encased in an evacuated container of insulating material and then the first and second honeycomb panels are secured together in an offset arrangement in order to minimize the contact between the edges of the honeycomb cores. Additional encased and vacuumed honeycomb core panels may be layered with the first and second honeycomb panels to further reduce the thermal conductivity and provide an insulation system that compares favorably with the best known insulation materials. The insulation system of the present invention has excellent strength characteristics and has a greater thermal resistance than conventional insulation system materials having approximately the same strength characteristics.

The present invention, in a second embodiment, may be viewed as a structural member having a high thermal resistance. The structural member is comprised of two or more honeycomb cores adapted for stacking in an offset arrangement and having strength parameters to provide a desired stiffness. One or more of the honeycomb cores is surrounded with an insulation material that provides a radiation barrier. The insulation material surrounding the one or more honeycomb cores is sealed and evacuated thereby providing a vacuum enclosure for one or more of the honeycomb cores.

Other systems, methods, features, and advantages of the present invention will be or become apparent to one with skill in the art upon examination of the following drawings and detailed description. It is intended that all such additional systems, methods, features, and advantages that are included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a front view of two honeycomb panels in an offset arrangement.

FIG. 2 is a top view of the honeycomb cores of FIG. 1.

FIGS. 3A-D illustrate several views of an offset arrangement for three hexagonal honeycomb cores similar to the arrangement of FIG. 1.

FIGS. 4A-D illustrate several views of an offset arrangement for the hexagonal honeycomb cores of FIG. 1 using a horizontal shift.

FIGS. 5A-D illustrate several views of the offset arrangement for the hexagonal honeycomb cores of FIG. 1 using a vertical shift.

FIG. 6 illustrates thermal performance characteristics of honeycomb cores contained within vacuum enclosures of radiation barrier material having two layers as in FIG. 1, three layers as in FIG. 4, and four layers.

FIG. 7 illustrates thermal performance characteristics of honeycomb cores of FIG. 6 having aluminum as the core material.

FIG. 8 is a table illustrating the reduction in conductivity due to the improvements provided by various aspects of the panel of FIG. 1.

### DETAILED DESCRIPTION OF THE PREFERRED EMBODIMENT

Several embodiments of an insulation system herein utilize the idea that several layers or stacks of honeycomb panels having cells of adjacent honeycomb cores that are offset, so as to reduce the area of contact, significantly reduces conduction heat transfer and hence increases the thermal resistance between the honeycomb panels. In addition, the total thermal resistance of an insulation system can be further increased by encasing and sealing each of the honeycomb cores within multiple layers of a radiation barrier material, such as aluminized mylar, thereby providing a sealed enclosure. To reduce convective heat transfer, increasing the thermal resistance even more, the interior of the sealed enclosure can be evacuated to provide a vacuum environment so that convective heat transfer within the honeycomb cells is negligible. Manufacturers of honeycomb cores, the structural element of honeycomb panels, have indicated that one way to improve the insulation properties of honeycomb panels, a conventional insulation system, would be to fill the honeycomb cores with foam or other known insulation materials. The conventional insulation system for honeycomb cores, as suggested by the manufacturers, does increase thermal resistance, but adds weight and may add significant cost. In contrast, embodiments of the present invention, as briefly described above and further illustrated in drawings and written text, provide highly insulating, light-weight insulation systems having excellent structural properties and low cost. The basic strength and stiffness attributes of the new insulation systems are similar to the conventional honeycomb insulation system, but the insulation properties are substantially greater. Much of the cost reduction is provided by the replacement of expensive high resistive materials with a vacuum. The stiffness and strength of the new insulation systems are slightly reduced since several layers of honeycomb core are not as strong as a single honeycomb core having the same thickness as the several layers. The difference in strength could be determined and would be understood by those skilled in the art.

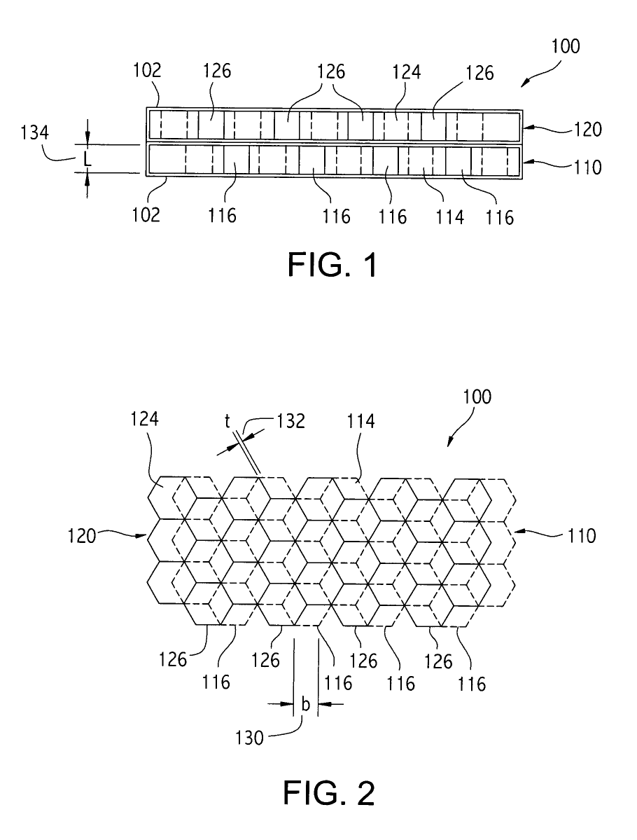

FIG. 1 illustrates an embodiment of an insulation system 100 having two layers of honeycomb panels. The insulation system 100, as viewed from the front in FIG. 1 has a first (the lower one) honeycomb panel 110 and a second (the top one) honeycomb panel 120 that is placed against the first honeycomb panel. Each of the honeycomb panels 110, 120 is similar and preferably is comprised of a honeycomb core 114, 124 encased within radiation barrier material 102. The radiation barrier material, that preferably encases the honeycomb cores 114, 124 with one or more layers is often referred to as Multi-Layer Insulation (MLI) material or “insulation material” by those skilled in the art. The insulation material 102 completely surrounds or encloses each of the honeycomb cores 114, 124 and preferably is sealed and evacuated thereby providing a vacuum container. In order to maintain a good vacuum it may be desirable to place a “getter” material within the honeycomb core to absorb gases that may diffuse through the insulation material 102 or may outgas from within. Because the interior of each cell is evacuated, heat conduction and convection transfer within each cell is insignificant. An additional benefit is provided when the vacuum container is located in an area that has pressure, such as one atmosphere, because the insulation material is flexible and takes a concave or dimpled shape about the size of the cell opening of the honeycomb core thereby reducing the contact area between adjacent honeycomb panels. In FIG. 1, no insulation material 102 is shown covering the ends of the honeycomb core in order that the relative position, providing the offset arrangement, of the end faces 116, 126 of the honeycomb cores 124, 121 may be seen. Each of the honeycomb cores has a cell height, “L”, 134 so that the total height of the two layer embodiment of the insulation system is equal to 2L plus the thickness of the layers of the insulation material 102.

A top view of the insulation system 100 of FIG. 1 is shown in FIG. 2. For illustration reasons, a limited number of hexagonal shaped cells are shown and the cells of the first honeycomb core 114 are drawn with dotted lines and the cells of the second honeycomb core 124 are drawn with solid lines. Although hexagonal shaped cells are preferred, other geometrically shaped cells could be used for the insulation system 100. The hexagonal shaped cells preferably have six sides of equal length, “b”, 130 and have walls with a cell thickness, “t”, 132. It is well known by those skilled in the art that two of the walls of the cells may have a thickness of 2t because of one manufacturing technique used for the fabrication of honeycomb cores with hexagonal shaped cells. However the inventors, to simplify analysis, consider that the thickness of all cell walls to be “t” 132. When observing the top view of FIG. 2, it is clear that the honeycomb cells of the first honeycomb core 114 are not aligned with the honeycomb cells of the second honeycomb core 124. Preferably, the second honeycomb core 124 is horizontally shifted to provide an offset, i.e. moved to the left or right, by a distance such as “b,” with respect to the first honeycomb core 114. The outward faces 116 of the first honeycomb core 114 are offset by a distance “b” from the outward faces 126 of the top honeycomb core 124 as shown in FIG. 1 and FIG. 2. A look at the top view of FIG. 2 shows the center of the cells of the first honeycomb core 114 in alignment with the intersection of the walls of the cells of second honeycomb core 124. Because the preferred offset arrangement minimizes contact between the walls of the cells of the honeycomb cores 114,124 the path for conductive heat transfer is minimized. The contact area is approximately 1.5 t² per cell for the shown offset arrangement whereas when the cells of the honeycomb cores are aligned the contact area is 3 bt per cell. Because the length of the sides, “b”, 130 of the cells may be ten or more times greater than the thickness of the walls, “t”, 132 the reduction in conductive heat transfer is significantly improved by the preferred offset arrangement of honeycomb cores 114, 124. In addition to the reduction in area provided by the offset arrangement, there is also a “contact resistance” that further reduces conduction heat transfer. Those skilled in the art would appreciate that other offset arrangements would provide similar results.

Another important benefit of the offset arrangement as shown in FIG. 1 and FIG. 2 is a reduction in radiation heat transfer because the geometric shape factor between the top layer and the bottom layer is reduced, as would be understood by one skilled in the art. However, for a conceptual understanding, consider that the intervening cell walls serve as partial radiation shields, reducing the heat transfer between the radiating area at the top layer from viewing the bottom layer. Conventional analysis shows that when the ratio of the cell wall side to the distance between the parallel planes has a value of the order of one or less, the resulting geometric shape factor is of the order of 0.25 to 0.5, whereas with no intervening walls between two parallel planes the geometric shape factor is one. Thus, the cells reduce the radiation heat transfer by a factor of around 2 and possibly to values as great as 4, depending on the geometry and the properties of the honeycomb materials.

To further reduce radiation heat transfer one or more layers of insulation material 102, a radiation barrier, are preferably placed over the cells of each of the honeycomb cores 114, 124 so that the insulation material 102 covers the opening or the interior of the hexagonal shaped cells. The insulation material 102 encases the honeycomb cores 114, 124 and is sealed to provide an enclosure that may be evacuated. Each of the enclosures preferably is evacuated providing a vacuum container for each honeycomb core 114, 124. When the vacuum container encasing the second honeycomb core 124 is placed in an offset arrangement on top of the vacuum container encasing the first honeycomb core 114, as illustrated in FIG. 1, the combined benefits of each aspect of the elements of the insulation system 100 provide an insulation system 100 with thermal resistance substantially equal to thermal resistance of the best known insulation materials. There are a wide variety of insulation materials 102 that may be used to encase the honeycomb core and that have the ability to retain a vacuum over long periods of time. Such materials include, for example, Teijin™ (an aluminized layer with polyester film and bonding materials), thin aluminum foil, aluminized mylar, kapton, and others. The encasing materials preferably are coated with vapor deposited metals, such as aluminum, gold or copper, to further reduce radiation heat transfer.

The insulation system 100 in a two panel embodiment as shown in FIG. 1 maintains strength and stiffness values close to the values of a single honeycomb panel having the same total thickness. For example, if the two honeycomb panels 110, 120 each has a thickness of “L” 134, assuming the insulation material 102 has an insignificant thickness, then the total thickness of the insulation system 100 is approximately 2L. A single honeycomb core, having a thickness of 2L, configured as a conventional panel may have somewhat better structural stiffness characteristics than the insulation system 100. However the thermal resistance of the insulation system 100 is likely to be significantly greater than thermal resistance the conventional panel. Because the insulation system 100 has a high thermal resistance with useful structural characteristics, the insulation system 100 may be utilized in a variety of products as mentioned in the invention background section. For example, the insulation system 100 may be placed inside the walls of a carrier used for transporting experimental materials into space and provide a carrier costing less, having good structural characteristics and performing as well or better than a carrier using conventional high thermal resistance materials. Further, a fuel tank requiring light-weight insulation having both high thermal resistance and good strength and stiffness would benefit from the insulation system 100 since it is well known, honeycomb cores can be fabricated to conform to a desired shape.

The insulation system 100 has a high thermal resistance in part because of the reduced cell wall contact provided by the offset arrangement as described above for hexagonal shaped cells. However, it is also possible to reduce cell contact area by stacking layers of honeycomb materials having cells with different geometric shapes. For example, one honeycomb core may have cells with a hexagonal shape and a second honeycomb core may have cells with a square shape. By appropriately selecting the dimensions of the hexagonal shapes and the square shapes of the cells and then placing the first honeycomb core against the second honeycomb core, benefits similar to the preferred offset arrangement may be realized. The benefits provided by reducing cell contact area may be accomplished by offsetting, by changing cell geometric shapes, by changing dimensions of same cell shapes, and other schemes. The manner in which cell contact area is reduced or minimized is not a limitation of the insulation system 100.

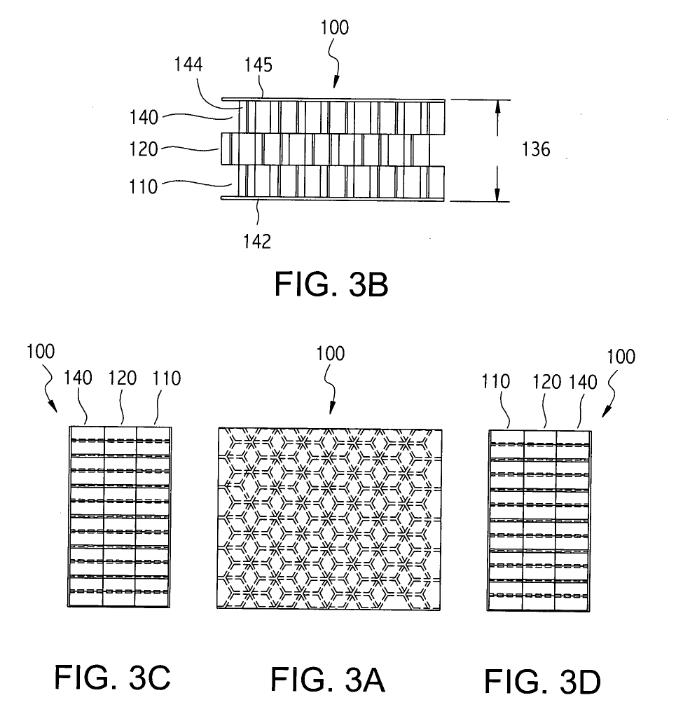

A second embodiment of the insulation system of FIG. 1 is illustrated in FIGS. 3A-D. The insulation system 100 of FIGS. 3A-D is comprised of three layers of honeycomb panels. The first and second panels 110, 120 may be identical to the panels in FIG. 1 and using the same offset arrangement. A third panel 140, having a third honeycomb core 144, preferably is placed against the second panel 120, as best seen in FIG. 3B. The third panel 140 preferably has hexagonal shaped cells of the same dimensions as the first and second honeycomb cores. The cells of the third honeycomb core are preferably offset with respect to the cells of the second honeycomb core 124 when the third panel 140 is placed against the second panel 120. Preferably, the cell walls of the third honeycomb core are aligned with the imaginary extension of the cell walls of the first honeycomb core 114 as is illustrated in the front view, FIG. 3A and the top view, FIG. 3B. If the desired height 136 shown in FIG. 3B is 2L, then the height of each of the three honeycomb panels 110, 120, 140 is adjusted accordingly.

FIGS. 3A-D also show a different arrangement of radiation barrier materials, based on the same inventive concept, wherein a first face sheet 145 preferably is bonded to the top of the third honeycomb core 144 and a second face sheet 142 is bonded to the bottom of the first honeycomb core 110. The sides of the thermal insulation system of FIGS. 3A-D preferably are sealed with insulation material to the face sheets providing a sealed enclosure for the honeycomb cores 114, 124, 144. The sealed enclosure preferably is evacuated to provide a vacuum container for the honeycomb cores. The placement of additional radiation barrier material between the honeycomb cores is optional and is dependent on the characteristics of the face sheets and the desired level of thermal resistance. The number of layers of offset honeycomb cores may be greater than the three shown in FIGS. 3A-D and each honeycomb core may be encased in a sealed vacuum enclosure or all of the honeycomb cores may be in one vacuum enclosure. The benefit of having a separate vacuum enclosure for each of the honeycomb cores is that if one of the sealed container loses a vacuum, the remaining enclosures still have a high value of thermal resistance so that the high thermal resistance of the insulation system 100 is not significantly reduced.

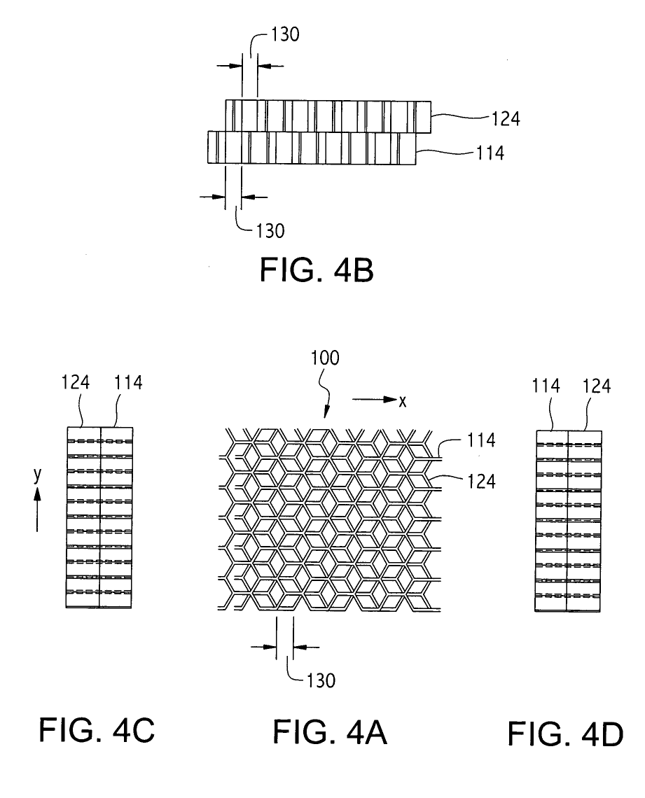

FIGS. 4A-D illustrate a horizontal shift for providing an offset arrangement between the first honeycomb core 114 and the second honeycomb core 124 similar to that of FIGS. 1 and 2. In a front view, FIG. 4A, the horizontal sides (the ones extending in the X-direction) of the cells of the first honeycomb core 114 are shown positioned at a distance “b” 130 (the length of each side of the hexagon) to the left of the cells of the second honeycomb core 124. The horizontal shift of one cell length can also be seen in the top view, FIG. 4B. When viewing the left view, FIG. 4C, or the right view, FIG. 4D, the shift cannot be observed since the left view and right view would only show vertical shifts, that is, movement in the Y-direction. It is preferable to have a shift equal to the length of a cell side, “b”, when making horizontal shifts since such a shift limits the cell edge contact to three areas between the cells of the first honeycomb core 114 and the second honeycomb core 124. When determining conductive heat transfer, the contact area is divided by two since adjacent cells of the same honeycomb core share contact areas. The effective contact area for a horizontal shift is approximately 1.5t².

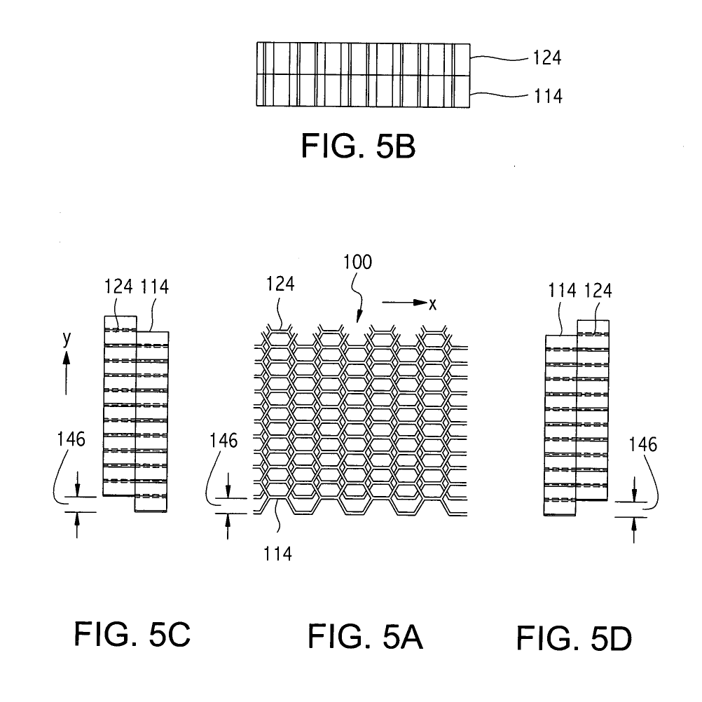

FIGS. 5A-D illustrate a vertical shift between the first honeycomb core 114 and the second honeycomb core 124. In a front view, FIG. 5A, the cells of the first honeycomb core 114 are shown positioned at a distance of about “0.86 b” 146 (half the distance between two parallel sides of a hexagon with sides of length “b”) in the Y-direction of the cells of the second honeycomb core 124. When viewing the top view, FIG. 5B, the shift is not observable. However the vertical shift is seen in the left view, FIG. 5C, and in the right view, FIG. 5D. When the vertical shift provides the offset arrangement there are four areas of contact per cell, but since adjacent cells have shared contact areas the effective contact area per cell is approximately 2 t².

Although either the horizontal shift or the vertical shift may provide the offset arrangement that greatly reduces the contact area between the ends of the cells of adjacent honeycomb cores, shifting in other directions, such as diagonally, may also effectively reduce the contact area. As previously mentioned, there are other techniques to reduce contact area, such as using cells with different geometric shapes and sizes in alternate layers of honeycomb cores. The shifting of adjacent honeycomb cores also reduces the radiation heat transfer because of a reduction in the geometric shape factor.

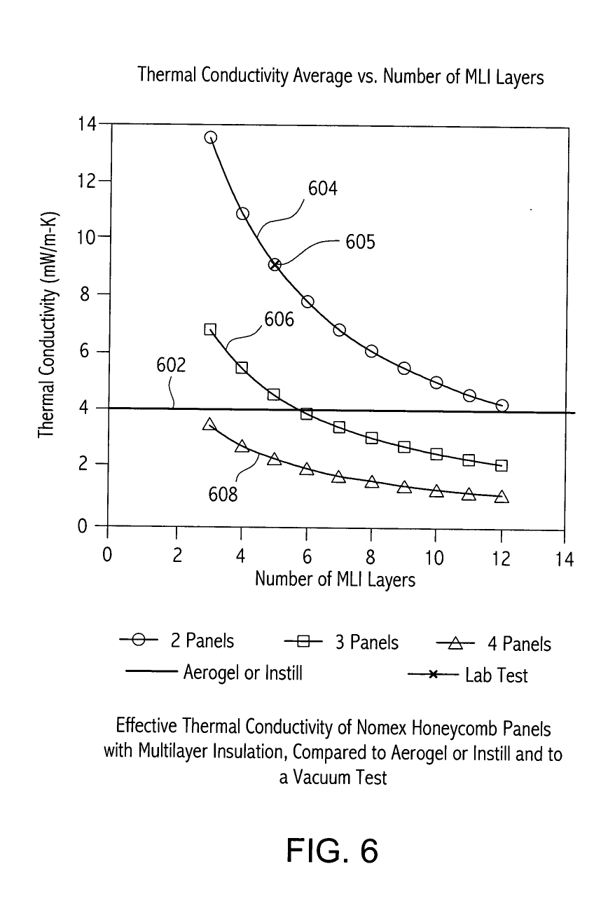

Values of conductivity for the insulation system 100 are illustrated by the thermal conductivity curves of FIG. 6. Low values of conductivity are desirable for insulation applications. The conductivity values of the thermal insulation system 100 are shown as a function of design parameters as curves 604, 606 and 608. The conductivity curves for the insulation system 100 is compared with conductivity of two of the best and well-known insulators (Aerogel® and Instill®) having conductivity value of 4 (units are on chart) as shown by curve 602. The curves were generated by analysis of the geometry of the insulation system and using known values for heat transfer parameters of the elements of the insulation system 100. A laboratory test shown as point 605 on curve 604, indicates that the analysis and test are in close agreement. The curve 604 represents 2 honeycomb cores 114, 124 with the abscissa indicating the number of layers of insulation material 102 (MLI layers). The layers are sealed about the honeycomb core and are evacuated providing a vacuum container as described earlier. Theoretically, when two honeycomb cores each having 6 layers of insulation material form the insulation system 100, in a vacuum (such as a space environment) the system is nearly as good as the best materials available. Curve 606 represents the insulation system 100 with three honeycomb cores and has a conductivity of around 2 when 12 layers of insulation material 102 (MLI) enclose each honeycomb core, making its conductivity value about half the value of some of the best-known materials. Hence, the insulation system 100 with three layers of offset honeycomb cores has a thermal resistance value about twice the value of some of the best-known insulation materials. When 4 honeycomb panels are placed in an offset arrangement, as shown in curve 608, the conductivity is reduced even further.

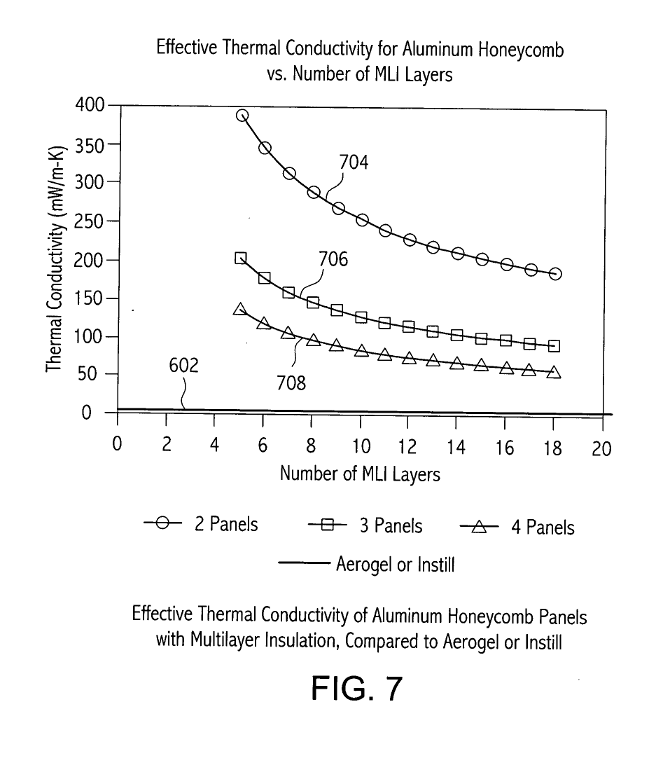

In some applications the insulation system 100 utilizing a honeycomb core material with a low conductivity, such as arimid fiber, insulating plastics and other well known insulation materials, may provide the desired thermal resistance, but may not provide the desired strength and stiffness. Although the stiffness of the insulation system 100 may be increased by bonding cell wall edges at their intersections, it may be desirable to select metals such as aluminum or an alloy for honeycomb core material since such materials have greater strength and stiffness. However many of the materials, such as metals, that have the desirable strength parameters may have high values of thermal conductivity making them poor insulators. The insulation system 100, using aluminum honeycomb cores, is a structure that has excellent strength and stiffness and is also a relatively good insulator. Although the conductivity of the insulation system 100 using aluminum, as shown in the performance curves 704, 706, 708 of FIG. 7, is greater than conductivity of the best in class materials 602, the insulation system 100 becomes a good insulator relative to aluminum, and of the same order of conductivity as that of conventional foam and fiberglass insulations at one atmosphere pressure. FIG. 7 illustrates that a material with high conductivity may serve as a good insulator if the number of honeycomb cores is large enough and the number of layers of insulation materials is large enough. The thermal conductivity of insulation system 100, when using aluminum honeycomb cores, varies from around 400 down to around 60. When four aluminum honeycomb cores, each having 18 layers of insulation material 102, are embodied as the insulation system 100, the system has a conductivity that is approximately 15 times the value of the best known insulating materials. However the combination characteristics of strong, light, and a good insulator at a reasonable cost make the aluminum embodiment of the insulation system 100 desirable for many applications.

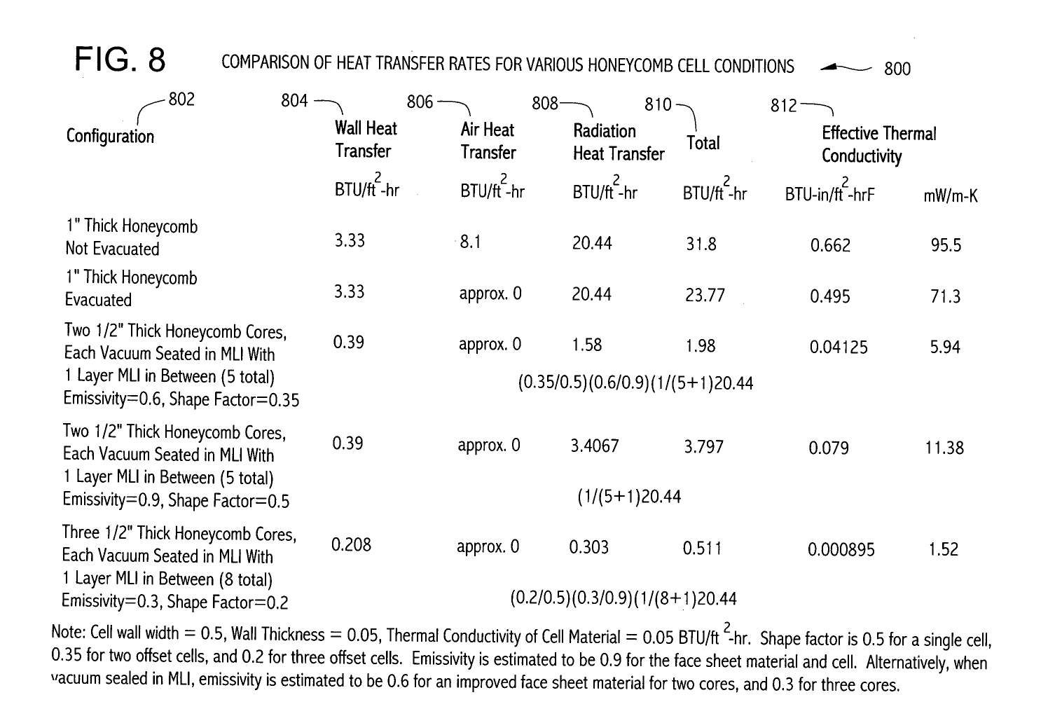

FIG. 8 illustrates the incremental improvements, reduction in conductivity, provided by the components of insulation system 100 described herein. The configuration of the components 802 is shown in the first column starting with a single one inch thick honeycomb core that is not evacuated and ending with three offset honeycomb cores each contained in a vacuum sealed enclosure of radiation barrier material. Improvements in wall heat transfer are shown in the second column 804 indicating an order of magnitude improvement. Air heat transfer goes from approximately 8.1 to approximately zero as shown in the third column 806, due to the evacuation of the sealed enclosure. Radiation heat transfer, shown in the fourth column 808, is reduced by over an order of magnitude. When the various reductions in heat transfers are totaled as shown in the fifth column 810 the benefits of the present invention are evident. When the total heat transfer values are converted to effective thermal efficiency as shown in the last column 812, the thermal conductivity has been reduced by a factor of around 62. In addition to illustrating the total performance improvement provided by each incremental improvement in the insulation system 100 using honeycomb cores, a person skilled in the art will find the comparison table instructive when designing a high thermal resistive system utilizing the principles taught herein.

The offset arrangements of the embodiments of the present invention described herein provide for a reduction in radiation and conduction heat transfer. The offset arrangements may be achieved, for example, by cutting each honeycomb core with the required offset and then stacking the cut cores against a common edge. In one embodiment, to obtain the offset arrangement, insulating inserts could be used, such that the cores would be stacked with the proper offset. Also if the honeycomb cores had different size cells then the layers of honeycomb cores would have minimum contact area irrespective of their placement. Spacers may also be used to ensure proper offset, as for example, by using a few “clip on” spacers that would fit into a cell or at the junction of three cells, formed such that when the next panel was placed it would have the proper offset. The technique of obtaining and maintaining the offset to minimize edge contact is not a limitation on the insulation system 100. Because vacuum sealing is a mature industry practice the inventors have not discussed the details for providing a sealed evacuated enclosure.

A series of tests were conducted to evaluate and verify the performance of the insulation system 100. The inventors showed that very low thermal conductivity is achieved with a simple version of the insulation system 100. Due to the limitations of the test apparatus only two honeycomb cores were used, each wrapped with a single sheet of insulation material. Each sheet was cut from an Ozark Trail Emergency Blanket, marketed by Wal-Mart. The two cores were placed in an offset arrangement between two outer cold plates, with a resistance heater foil between the two. The heat flux was determined by measuring the electric power of the resistance heater foil. Care was taken to ensure steady-state operation, minimum effects of the edges, etc. The test technique was also used to measure the performance of best in class insulators such as Aerogel. The results of the tests verified the concept and provided information for predicting the properties of the insulation system 100. The insulation system 100 may also function as a space debris shield, a sound attenuator or a vibration attenuator.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. An insulation system comprising:
a first honeycomb panel having a honeycomb core encased in an evacuated container of insulating material; and
a second honeycomb panel having a honeycomb core encased in an evacuated container of insulating material, wherein the first and second panel are placed in an offset arrangement.

2. The insulation system of claim 1 further comprising additional honeycomb panels each having a honeycomb core encased in an evacuated container of insulating material, wherein the additional panels are placed in an offset arrangement.

3. The insulation system of claim 1 wherein the cells of honeycomb have a hexagonal shape.

4. A structural member having a combination of substantial stiffness and a high thermal resistance, the structural member comprising:
two or more honeycomb cores adapted for stacking in an offset arrangement and having parameters selected to provide a desired stiffness; and
one or more layers of thermal insulation materials selected to provide a desired thermal resistance, the thermal insulation materials surrounding each of the honeycomb cores forming a sealed container that is evacuated to provide vacuum containment of the honeycomb cores.

5. The structural member of claim 4 wherein the honeycomb core has a hexagonal shape.

6. The structural member of claim 5 wherein the offset arrangement is provided by a horizontal shift.

7. The structural member of claim 5 wherein the offset arrangement is provided by a vertical shift.

8. The structural member of claim 4 wherein the offset is provided by utilizing honeycomb cores of different geometrical shapes.

9. The structural member of claim 4 wherein the honeycomb core material is comprised of a material having low conductivity.

10. The structural member of claim 4 wherein the honeycomb core material is comprised of a material having high conductivity and high strength parameters.

11. The structural member of claim 4 wherein the honeycomb core cell walls are comprised of aluminum.

12. The structural member of claim 11 wherein the thermal insulation material is aluminized mylar.

13. A structural system having a high thermal resistance comprising:
a plurality of honeycomb cores, wherein each of the honeycomb cores has cells with the same geometric shape and further wherein each of the honeycomb cores has the same thickness;
vacuum containers for separately enclosing each of the honeycomb cores, wherein the honeycomb cores are placed in the containers and the containers are evacuated; and
a means for securing an offset stacked arrangement of the vacuum contained honeycomb cores.

14. The structural system of claim 13 wherein each of the cores has the same thickness.

15. The structural system of claim 13 wherein the core material has low conductivity.

16. The structural system of claim 13 wherein the vacuum containers have multiple layers of radiation blocking material.

17. The structural system of claim 13 wherein the cell geometrical shape is selected to minimize the contact area between adjacent cell walls of the stack of enclosed honeycomb cores.

18. The structural system of claim 13 wherein the vacuum containers are comprised of multilayers of thermal material.

19. A method of providing an insulation system comprising:
providing a first and second honeycomb core;
encasing each of the cores in an evacuated container of insulation material thereby providing a first honeycomb panel and a second honeycomb panel; and
placing the panels in an offset arrangement.

20. The method of claim 19 further comprising placing additional honeycomb panels in an offset arrangement with the first and second panels.

21. An insulation system comprising:
a first honeycomb core; and
a second honeycomb core, wherein the first honeycomb core and the second honeycomb core are stacked in an offset arrangement.

22. The insulation system of claim 21 wherein at least one of the honeycomb cores is wrapped with insulation material.

23. The insulation system of claim 21 wherein at least one of the honeycomb cores is enclosed in an evacuated container.
